(19) United States
(12) Patent Application Publication
(10) Pub. No.: US 2019/0281882 A1
(43) Pub. Date: Sep. 19, 2019

(54) ROBOT, METHOD OF OPERATING THE ROBOT, AND APPLICATION SYSTEM

(71) Applicant: KAWASAKI JUKOGYO KABUSHIKI KAISHA, Kobe-shi, Hyogo (JP)

(72) Inventors: Kenji BANDO, Nishinomiya-shi (JP); Shuhei KURAOKA, Akashi-shi (JP)

(73) Assignee: KAWASAKI JUKOGYO KABUSHIKI KAISHA, Kobe-shi, Hyogo (JP)

(21) Appl. No.: 16/465,052

(22) PCT Filed: Nov. 24, 2017
(86) PCT No.: PCT/JP2017/042241

§ 371 Date: May 29, 2019

(30) Foreign Application Priority Data
Nov. 29, 2016 (JP) 2016-230788

(51) Int. Cl. A23P 20/15; B25J 9/16

(52) U.S. Cl. CPC A23P 20/15; B25J 9/1697

(57) ABSTRACT

A robot configured to apply liquid to food accommodated in a container includes an imaging unit configured to image one of the container and the food, a first arm configured to move a dispensing unit configured to dispense the liquid, a second arm configured to move a spreading unit configured to spread the liquid dispensed on the food, and a control device. The control device actuates the first arm to move the dispensing unit based on a position and a tilt of the one of the container and the food imaged by the imaging unit and actuates the second arm to move the spreading unit based on the position and the tilt.

### TECHNICAL FIELD

The present disclosure relates to a robot, a method of operating the robot, and an application system.

### BACKGROUND ART

Patent Document 1, as an example, discloses a brush application device which applies liquid to food. This brush application device includes an application brush and a spreading brush. The brushes are fixed above a food-conveying conveyor and have a width that is approximately equal to the width of the conveyor in a direction perpendicular to the conveying direction of the conveyor. The application brush applies condiment to the food being conveyed on the conveyor, and the spreading brush then spreads the condiment.

### REFERENCE DOCUMENT OF CONVENTIONAL ART

### Patent Document

[Patent Document 1] JP1999-196772A

### DESCRIPTION OF THE DISCLOSURE

### Problems to be Solved by the Disclosure

The brush application device of Patent Document 1 described above has room for improvement. The device requires the use of a special spreading brush having substantially the same width as the conveyor in order to spread the liquid applied to the food.

The present disclosure, made in view of this conventional problem, has a purpose to provide a robot capable of readily applying liquid to food, a method of operating such a robot, and an application system.

### SUMMARY OF THE DISCLOSURE

In order to solve the conventional problem, according to one aspect of the present disclosure, a robot is provided which is configured to apply liquid to food accommodated in a container, and includes an imaging unit configured to image one of the container and the food, a first arm configured to move a dispensing unit configured to dispense the liquid, a second arm configured to move a spreading unit configured to spread the liquid dispensed on the food, and a control device. The control device actuates the first arm to move the dispensing unit based on a position and a tilt of the one of the container and the food imaged by the imaging unit and actuates the second arm to move the spreading unit based on the position and the tilt.

According to this structure, the dispensing unit and the spreading unit can be moved according to the position and tilt of the container or the food. The robot is therefore capable of spreading the liquid dispensed onto the food, thereby readily applying the liquid to the food without using a special brush. The robot is also capable of simultaneously dispensing a liquid from the dispensing unit and spreading the liquid with the spreading unit, thereby uniformly applying the liquid before the liquid drips from the food or becomes dry.

With the robot, the first arm may move the dispensing unit in a direction in dispensing the liquid, the direction being different from a direction in which the second arm moves the spreading unit in spreading the liquid. According to this structure, by moving the spreading unit in the different direction from the direction in which a streak of dispensed liquid extends, the liquid can be spread more uniformly.

With the robot, the spreading unit may have a shorter length than does the food in a direction perpendicular to the moving direction of the spreading unit in spreading the liquid. According to this structure, a typical spreading unit such as a brush has a length shorter than the length of the food in the direction perpendicular to the moving direction of the spreading unit. Using such a spreading unit, the robot is still capable of readily applying a liquid to the food by moving the spreading unit according to the position and tilt of the container.

With the robot, the imaging unit may be provided to the first arm. According to this structure, since the dispensing unit, the spreading unit, and the imaging unit are all provided to the robot, there is no need to prepare the imaging unit separately.

According to another aspect of the present disclosure, an application system includes either one of the robot described above and a conveying unit configured to convey the container. According to this structure, the robot can dispense and spread the liquid successively on the food in the containers conveyed by the conveying unit. The robot is hence capable of easily and efficiently applying the liquid onto the plural pieces of food.

With the application system, the robot may be disposed relative to the conveying unit in such a manner that the imaging unit is located upstream of the dispensing unit in a conveying direction of the conveying unit, and the dispensing unit is located upstream of the spreading unit in the conveying direction. According to this structure, the robot can successively image plural pieces of food being conveyed by the conveying unit, dispense a liquid onto them, and then spread the liquid on them, thereby efficiently applying the liquid to the food.

According to still another aspect of the present disclosure, a method of operating a robot is provided, the robot including an imaging unit configured to image one of a container and food, a first arm configured to move a dispensing unit configured to dispense liquid, and a second arm configured to move a spreading unit configured to spread the liquid dispensed on the food. The method includes actuating, based on a position and a tilt of the one of the container and food imaged by the imaging unit, the first arm to move the dispensing unit, and the second arm to move the spreading unit. According to this method, since the spreading unit can be moved according to the position and the tilt of the container or the food, the robot is capable of spreading the liquid dispensed onto the food, thereby readily applying the liquid to the food without using a special brush.

### Effect of the Disclosure

According to the robot, the method of operating the robot, and the application system of the present disclosure, liquid can easily be applied to the food.

### BRIEF DESCRIPTION OF DRAWINGS

FIG. 1 is a schematic view schematically showing a structure of a robot according to Embodiment 1 of the present disclosure.

FIG. 2 is a functional block diagram schematically showing a configuration of a control device for the robot shown in FIG. 1.

FIG. 3 is a view showing a state where the robot shown in FIG. 1 images a container and spreads liquid on food.

FIG. 4 is a view showing a state where the robot shown in FIG. 1 dispenses liquid onto food and spreads the liquid on the food.

### MODES FOR CARRYING OUT THE DISCLOSURE

The following will describe embodiments of the present disclosure with reference to the drawings. Identical or equivalent components will be denoted by the same reference characters in the drawings, and description thereof is not repeated. The drawings may selectively show some of the components to describe the present disclosure and omit the other members. The present disclosure is by no means limited to the following embodiments.

### Embodiment 1

### [Structure of Robot]

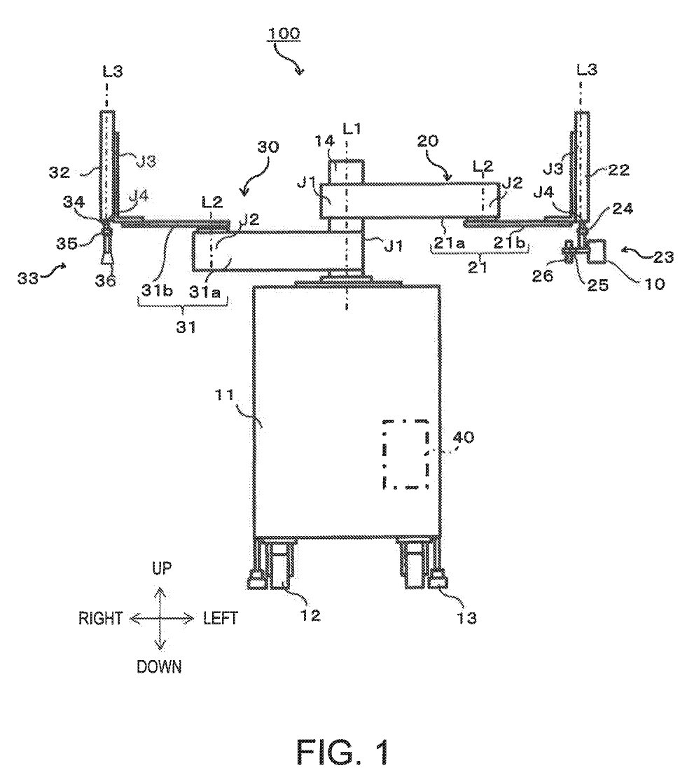

As shown in FIG. 1, a robot 100 according to Embodiment 1 is a robot which applies liquid to food contained in a container and includes an imaging unit 10, a first arm 20, a second arm 30, and a control device 40. The robot 100 is, for example, a horizontal articulated robot. This is however not the only possibility, and the robot 100 may alternatively be, for example, a vertical articulated robot.

The robot 100 includes a carriage 11. The carriage 11 has wheels 12 and a securing unit 13 on its bottom. The robot 100 can move on the wheels 12 and may be secured with respect to the floor by the securing unit 13. The carriage 11 houses the control device 40 therein.

A base shaft 14 is fixed to the top of the carriage 11. The first and second arms 20 and 30 are disposed on the base shaft 14 in such a manner that the first and second arms 20 and 30 can pivot about a rotation axis L1 passing through the axis of the base shaft 14. The first and second arms 20 and 30 are disposed with a difference in height therebetween. The first and second arms 20 and 30 are structured so as to operate independently and collaboratively.

The first arm 20 includes a first arm part 21, a first wrist part 22, a first hand part 23, and a first attaching part 24. The second arm 30 includes a second arm part 31, a second wrist part 32, a second hand part 33, and a second attaching part 34. In this example, the first arm 20 and the second arm 30 are described as having substantially the same structure except for the first hand part 23 and the second hand part 33. This is however not the only possibility: the arm parts 21 and 31 and the wrist parts 22 and 32 may, for example, differ in the first arm 20 and the second arm 30.

The first arm part 21 includes a first a link 21a and a first b link 21b. The second arm part 31 includes a second a link 31a and a second b link 31b. All these links 21a, 21b, 31a, 31b are shaped generally like a rectangular parallelepiped. Each of the links 21a and 31a has a rotary joint J1 at its base end and a rotary joint J2 at its distal end. Each of the links 21a and 31a is, at its base end, coupled to the base shaft 14 via the rotary joint J1 so that the links 21a and 31a can pivot around the rotation axis L1 via the rotary joint J1.

The link 21b or 31b is, at its base end, coupled to the distal end of the link 21a or 31a via the rotary joint J2 so that the link 21b or 31b can pivot around a rotation axis L2 via the rotary joint J2, respectively. Each of the links 21b and 31b has a linear-motion joint J3 at its distal end.

The wrist parts 22 and 32 are coupled to the distal ends of the links 21b and 31b via the linear-motion joint J3 so as to be able to move up and down relative to the links 21b and 31b, respectively. Each of the wrist parts 22 and 32 has a rotary joint J4 at its bottom end, and the rotary joints J4 have the respective attaching parts 24 and 34 at their bottom ends.

The attaching parts 24 and 34 are structured so that the respective hand parts 23 and 33 can be detached. For example, each of the attaching parts 24 and 34 includes a pair of bar members separated by an adjustable distance. The attaching parts 24 and 34 sandwich the respective hand parts 23 and 33 between the pair of bar members to attach the hand parts 23 and 33 to the wrist parts 22 and 32. This structure enables the hand parts 23 and 33 to pivot around rotation axes L3 via the rotary joints J4. The bar members may have a bent distal end.

The first hand part 23 is disposed at the distal end of the first arm 20 and includes a first holding part 25 and the imaging unit 10 both of which are attached by the first attaching part 24 in a detachable manner. The second hand part 33 is disposed at the distal end of the second arm 30 and includes a second holding part 35 which is attached by the second attaching part 34 in a detachable manner. The first hand part 23 and the second hand part 33 will be described later in detail.

Each of the joints J1 to J4 of the first arm 20 and the second arm 30 is provided with a drive motor (not shown) as an example of an actuator which relatively rotates or moves up and down the two members coupled by the joint. The drive motor may be, for example, a servo motor servo-controlled by the control device 40. Each of the joint J1 to J4 is also provided with a rotation sensor (not shown) which detects the rotational position of the drive motor and an electric current sensor (not shown) which detects electric current through which the rotation of the drive motor is controlled. The rotation sensor may be, for example, an encoder.

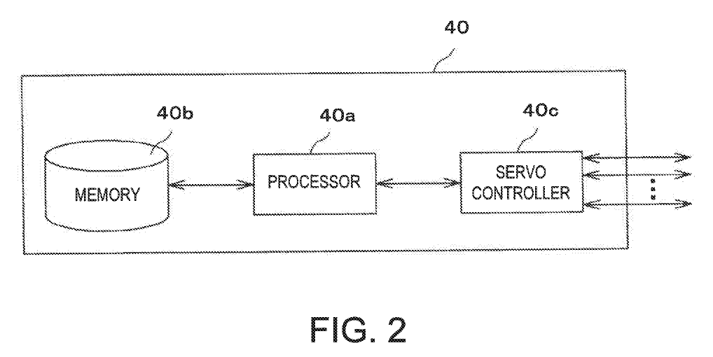

Next, a description will be given of the control device 40 with reference to FIG. 2. The control device 40 includes a processor 40a such as a CPU, a memory 40b such as a ROM and/or a RAM, and a servo controller 40c. The control device 40 is, for example, a robot controller including a microcontroller or like computer. The control device 40 may be built from a single control device 40 for centralized control or from plural control devices 40 which operate collaboratively for distributed control. The memory 40b is provided as a part of the control device 40 in Embodiment 1. Alternatively, the memory 40b may be provided separately from the control device 40.

The memory 40b contains information, such as a basic program and various fixed data, for the robot controller. The processor 40a retrieves and executes the basic program and other software contained in the memory 40b to control various operations of the robot 100. In other words, the processor 40a generates control instructions for the robot 100 for output to the servo controller 40c. The servo controller 40c is configured to control the driving of the servo motors associated with the joints J1 to J4 of the arms 20 and 30 of the robot 100 based on the control instructions generated by the processor 40a. For example, the control device 40 actuates the first arm 20 and the second arm 30 to move a dispensing unit 26 and a spreading unit 36, respectively, based on the position and tilt of the container or food imaged by the imaging unit 10.

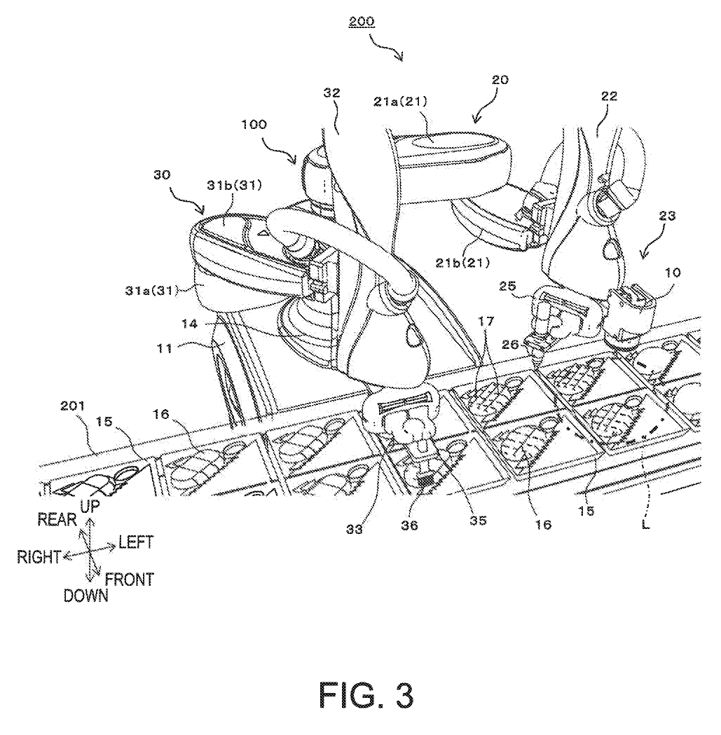

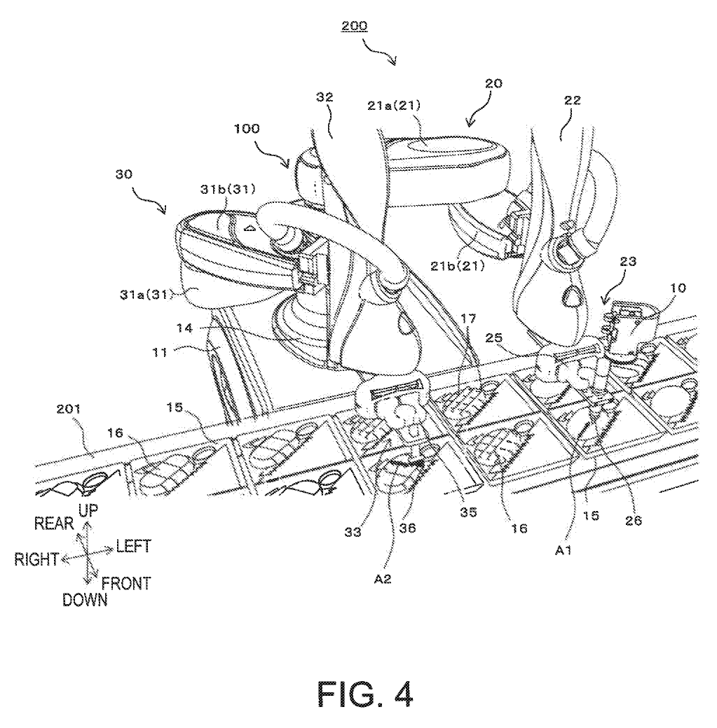

Next, a description will be given of the first hand part 23 of the first arm 20 with reference to FIGS. 3 and 4. The first hand part 23 includes the imaging unit 10 and the first holding part 25, which are connected at a prescribed angle to the first wrist part 22 via the first attaching part 24 (see FIG. 1). The second hand part 33 includes the second holding part 35 and is connected to the first wrist part 32 via the second attaching part 34 (see FIG. 1).

The imaging unit 10 captures an image of a container 15 or food 16 and may be a camera such as a vision camera. The imaging unit 10 is positioned so as to have its optical axis matched with the ascending and descending direction (vertical direction) of the first wrist part 22 of the first arm 20 and to look downward. The imaging unit 10 outputs the captured image to the control device 40 which in turn analyzes the image to check, for example, the position and shape of the object.

The first holding part 25 holds the dispensing unit 26 for dispensing liquid and includes, for example, a pair of sandwiching parts. The pair of sandwiching parts is driven by an actuator or like driving unit (not shown) so as to change the distance separating the sandwiching parts. The sandwiching parts hold an attaching part of the dispensing unit 26 by reducing the distance separating the sandwiching parts. The sandwiching parts may be each shaped like, for example, a plate and have opposing peripheries curved along the surface of the attaching part of the dispensing unit 26, so that the sandwiching parts can conform to the attaching part.

The dispensing unit 26 is a dispenser for dispensing the liquid from a container and is connected to a driving unit such as an actuator (not shown) to apply pressure to the liquid. The dispensing unit 26 includes, for example, a cylinder and a piston. The liquid is dispensed by the motion of the piston. The dispensing unit 26 has its attaching part held by the first holding part 25. The dispensing unit 26 is attached to the first arm 20 in such a manner that the dispensing unit 26 has its dispensing port open downward when this attaching part is held by the first holding part 25.

As the rotary joints J1, J2, and J4 (see FIG. 1) allow various parts of the first arm 20 to pivot around the respective rotation axes L1, L2, and L3 (see FIG. 1), the imaging unit 10 and the dispensing unit 26 can move in the left-and-right direction as well as in the front-and-rear direction. The imaging unit 10 and the dispensing unit 26 can also move vertically since the linear-motion joint J3 (see FIG. 1) allows the first wrist part 22 of the first arm 20 to move up and down relative to the first b link 21b. The first arm 20 can, as detailed here, move the imaging unit 10 and the dispensing unit 26.

The second holding part 35 holds the spreading unit 36 for spreading the liquid dispensed onto the food 16 and includes, for example, a pair of sandwiching parts. The pair of sandwiching parts is driven by an actuator or like driving unit (not shown) so as to change the distance separating the sandwiching parts. The sandwiching parts hold an attaching part of the spreading unit 36 by reducing the distance separating the sandwiching parts. The sandwiching parts may be each shaped like, for example, a plate and have opposing peripheries curved along the surface of the attaching part of the spreading unit 36, so that the sandwiching parts can conform to the attaching part.

The spreading unit 36 spreads and extends a liquid on the food 16. Examples of such a spreading unit 36 include a brush, a roller, a trowel, and a spatula. In a direction parallel to an application surface of the food 16 (horizontal direction), the spreading unit 36 has a shorter dimension than does the food 16, when measured in a direction perpendicular to the direction in which the spreading unit 36 moves in spreading a liquid. The spreading unit 36 has its attaching part held by the second holding part 35. The spreading unit 36 is attached to the second arm 30 in such a manner that the spreading unit 36 has its bottom end positioned horizontally when this attaching part is held by the second holding part 35.

As the rotary joints J1, J2, and J4 (see FIG. 1) allow various parts of the second arm 30 to pivot around the respective rotation axes L1, L2, and U (see FIG. 1), the spreading unit 36 can move in the left-and-right direction as well as in the front-and-rear direction. The spreading unit 36 can also move vertically since the linear-motion joint J3 (see FIG. 1) allows the second wrist part 32 of the second arm 30 to move up and down relative to the second b link 31b. The second arm 30 can, as detailed here, move the spreading unit 36.

### [Structure of Application System]

Next, a description will be given of a structure of an application system 200 with reference to FIGS. 3 and 4. The application system 200 includes the robot 100 and a conveying unit 201. The conveying unit 201, disposed in front of the robot 100, may be, for example, a belt conveyor for conveying the container 15 and has a placement surface on which the container 15 is to be placed. The placement surface of the conveying unit 201 is horizontal, i.e., perpendicular to the ascending/descending direction (vertical direction) of the wrist parts 22 and 32, and is so disposed that the container 15 on the placement surface can move from the first hand part 23 side to the second hand part 33 side.

The first hand part 23 of the robot 100 is hence disposed upstream of the second hand part 33 in the conveying direction of the conveying unit 201. The imaging unit 10 is disposed upstream of the dispensing unit 26 of the first holding part 25 in the conveying direction. The dispensing unit 26 is disposed upstream of the spreading unit 36 of the second holding part 35 in the conveying direction. A workbench on which the container 15 is to be placed, as an example, may be disposed, instead of the conveying unit 201, in front of the robot 100.

On the placement surface of the conveying unit 201 are there arranged two rows of containers 15, sitting next to each other in the front-and-rear direction. Each row includes a plurality of containers 15 sitting next to each other in the left-and-right direction. Each container 15 has an open top, a closed bottom, and four sidewalls rising from the bottom. The inside of the container 15 is divided along a diagonal into two halves. One of the halves is filled with rice, and the other half contains a hamburg steak (food) 16 and an egg. The food 16 is positioned so as to have its length oblique to the conveying direction of the conveying unit 201 and parallel to the diagonal of the container 15. Note that the containers 15 may be arranged in a single row or in plural (three or more) rows on the placement surface of the conveying unit 201, and the rows may be parallel to each other in the front-and-rear direction.

### [Method of Operating Robot]

Next, a description will be given of a method of operating the robot 100 according to Embodiment 1 with reference to FIGS. 3 and 4. This method is implemented by the control device 40. This example will describe sauce (liquid) being applied to the hamburg steak (food) 16 contained in a lunch box or Bento box (container) 15.

The container 15 however needs only to have an open top and is not necessarily a lunch box. The food 16 needs only to be solid and is not necessarily a hamburg steak. Other examples of the food 16 include an omelet over rice and Okonomiyaki (savory pancake containing meat or seafood and vegetables). The liquid needs only to be dispensable and spreadable and is not necessarily sauce. Other examples of the liquid include viscous condiments and fluid condiments.

First, as shown in FIG. 3, for example, the container 15 containing the food 16 is placed onto the placement surface of the conveying unit 201 by a worker and then conveyed to a location in front of the robot 100. The container 15 may happen to tilt relative to the conveying direction of the conveying unit 201 or may happen to move out of its prescribed position, when placed on the placement surface or while being conveyed.

Accordingly, the first arm 20 moves the imaging unit 10 to a location above the container 15 in order to acquire the position and tilt of the container 15. The imaging unit 10 then captures an image of the container 15 and outputs the captured image to the control device 40 either on the elapse of every prescribed time determined based on conveying speed or at a prescribed timing given, for example, by a detection signal from a sensor (not shown) which detects the position of the container 15 being conveyed. The control device 40 then processes the image to acquire positional information on the position of the container 15 in a direction parallel to the placement surface and the tilt of the container 15 with respect to the direction parallel to the placement surface.

In the image processing, the control device 40 can acquire the position and tilt of the container 15 in the front-and-rear direction and in the left-and-right direction from the positional information of those sidewalls of the container 15 which extend in the front-and-rear direction and those sidewalls of the container 15 which extend in the left-and-right direction. Since the containers 15 have the same shape and color, the control device 40 can more accurately and more readily acquire positional information on the position and tilt of the container 15.

Alternatively, the imaging unit 10 may simultaneously image two containers 15 which are next to each other in the front-and-rear direction. As a further alternative, the imaging unit 10 may image not the entire two containers 15, but a part of each container 15 as shown in the imaging range indicated by a dash-dot line L in FIG. 3. For example, for one of the two containers 15 that is in the rear side (the one closer to the robot 100), the imaging unit 10 is set up to image one of the two sidewalls extending in the left-and-right direction which is in the front side and also image one of the two sidewalls extending in the front-and-rear direction which is either upstream or downstream of the other. Meanwhile, for the container 15 which is in the front side (the one farther from the robot 100), the imaging unit 10 is set up to image one of the two sidewalls extending in the left-and-right direction which is in the rear side and also image one of the two sidewalls extending in the front-and-rear direction which is either upstream or downstream of the other. The control device 40 can hence acquire the positional information on the position and tilt of the container 15 in the front-and-rear direction and in the left-and-right direction from the positional information of one of its sidewalls extending in the front-and-rear direction and one of its sidewalls extending in the left-and-right direction.

This arrangement requires no special imaging unit 10 capable of imaging a wide space, thereby reducing additional cost. The arrangement also does not require the imaging unit 10 to be positioned away from the dispensing unit 26 for a long focal length, which contributes to building a compact product. Furthermore, the arrangement does not need to capture separate images of containers 15 sitting next to each other in the front-and-rear direction, which allows for a reduction in machine time.

Subsequently, the first arm 20 moves the dispensing unit 26, instead of the imaging unit 10, to the location above the container 15. The first arm 20 then moves the dispensing unit 26 over the food 16 inside the container 15 based on the positional information of the container 15 while the dispensing unit 26 is dispensing the liquid from its dispensing port.

For example, because the position of the food 16 inside the container 15 and the tilt of the food 16 relative to the container 15 are predetermined, the position and tilt of the food 16 are determined based on the position and tilt of the container 15. Next, the moving range and moving direction of the dispensing unit 26 are corrected based on the position and tilt of the food 16 because the moving direction and moving range of the dispensing unit 26 in dispensing the liquid are predetermined according to, for example, the size and tilt of the food 16. The dispensing unit 26 is placed at a starting position of this moving range and then moved from the starting position based on moving direction A1 (see FIG. 4) and the moving range while dispensing the liquid from its dispensing port. This arrangement enables the delivery of the liquid to a desired location on the food 16.

In this example, the dispensing unit 26 is first placed near a first one of the ends of the food 16 in the lengthwise direction and then moved in the lengthwise direction while dispensing the liquid. The dispensing unit 26 stops dispensing the liquid near the other, second end of the food 16. Thereafter, the dispensing unit 26 is moved to the downstream of the conveying unit 201 without dispensing the liquid. The dispensing unit 26 is then moved, while dispensing the liquid, parallel to the previous moving direction from near the second end of the food 16 to near the first end where the dispensing unit 26 stops dispensing. This series of motions is repeated to form a plurality of streaks 17 of the liquid on the application surface of the food 16.

The second arm 30 moves the spreading unit 36 based on the positional information of the container 15. In this situation, the spreading unit 36 is placed above the prescribed position on the food 16 based on the position and tilt of the food 16 which can in turn vary with the position and tilt of the container 15. The spreading unit 36 is then moved downward until its bottom end touches the food 16.

The moving direction and moving range of the spreading unit 36 are corrected based on the position and tilt of the food 16 because the moving direction and moving range of the spreading unit 36 in spreading the liquid are predetermined according to, for example, the size and tilt of the food 16. The spreading unit 36 is moved based on this moving range and moving direction A2 (see FIG. 4). In that motion, the spreading unit 36 is oriented based on the tilt of the food 16 in such a manner that the lengthwise direction of the bottom end of the spreading unit 36 is perpendicular to the moving direction of the spreading unit 36.

This arrangement allows the liquid to be more uniformly spread across the application surface of the food 16. The arrangement also enables simultaneous dispensing of the liquid onto a piece of food 16 and spreading of the previously dispensed liquid on another piece of food 16. Therefore, the liquid can be spread before the liquid drips from the food 16 or becomes dry. Note that so long as these dispensing and spreading actions are performed in parallel, the dispensing and spreading actions are not necessarily started and finished at the same timings. For example, the dispensing and spreading actions may be started or finished at different timings. As another alternative, the dispensing and spreading actions may be performed independently.

Moving direction A1 (see FIG. 4) in which the first arm 20 moves the dispensing unit 26 in dispensing the liquid may differ from moving direction A2 (see FIG. 4) in which the second arm 30 moves the spreading unit 36 in spreading the liquid. For example, the dispensing unit 26 is moved in the lengthwise direction of the food 16 in order to form a streak 17 of the liquid extending in the lengthwise direction on the food 16. Meanwhile, the spreading unit 36 is moved in a direction perpendicular to the lengthwise direction of the food 16 in order to spread, in the direction perpendicular to the lengthwise direction, the streak 17 of the liquid extending in the lengthwise direction. This arrangement enables more uniform and more efficient application of the liquid onto the food 16.

After the liquid on the food 16 is spread in this manner, the second arm 30 moves the spreading unit 36 up to a position higher than the height of the sidewalls of the container 15 and then moves the spreading unit 36 to above the food 16 inside another container 15. This series of motions can move the spreading unit 36 without letting the spreading unit 36 touch the sidewalls of the container 15 and hence without letting the liquid adhering to the spreading unit 36 smear the sidewalls, even if the food 16 is lower in height than the sidewalls of the container 15.

In the robot 100 configured as described above, the control device 40 actuates the first arm 20 so as to move the dispensing unit 26 and actuates the second arm 30 so as to move the spreading unit 36, both based on the position and tilt of the container 15 imaged by the imaging unit 10. This arrangement enables the dispensing unit 26 and the spreading unit 36 to be moved according to the position and tilt, of the food 16 inside the container 15, which can in turn vary with the position and tilt of the container 15. The robot 100 is therefore capable of spreading the liquid dispensed onto the food 16, thereby readily applying the liquid to the food 16 without having to use a special brush. The robot 100 is also capable of simultaneously dispensing a liquid from the dispensing unit 26 and spreading the liquid with the spreading unit 36, thereby uniformly applying the liquid before the liquid drips from the food 16 or becomes dry.

In addition, in the robot 100, the first arm 20 moves the dispensing unit 26 in a different direction in dispensing the liquid than the second arm 30 moves the spreading unit 36 in spreading the liquid. By moving the spreading unit 36 in a different direction from the direction in which the streak 17 of dispensed liquid extends, this arrangement is capable of more efficiently and more uniformly spreading the liquid.

Additionally, in the robot 100, the spreading unit 36 has a length (width) shorter than the length of the food 16 in the direction perpendicular to moving direction A2 (see FIG. 4) of the spreading unit 36 in the spreading action. A typical spreading unit 36 such as a brush has a length shorter than the length of the food 16 in the direction perpendicular to the moving direction of the spreading unit 36. Using such a spreading unit 36, the robot 100 is still capable of readily applying a liquid to the food 16 by moving the spreading unit 36 according to the position and tilt of the container 15.

Furthermore, in the robot 100, the imaging unit 10 is provided on the first arm 20. In this structure, since the dispensing unit 26, the spreading unit 36, and the imaging unit 10 are all provided on the robot 100, there is no need to prepare the imaging unit 10 separately.

Furthermore, the application system 200 includes the robot 100 and the conveying unit 201 for conveying the container 15. This structure enables the robot 100 to dispense and spread the liquid successively on plural pieces of food 16 in the containers 15 conveyed by the conveying unit 201. The robot 100 is hence capable of easily and efficiently applying the liquid onto the plural pieces of food 16.

In the application system 200, the robot 100 is positioned relative to the conveying unit 201 in such a manner that the imaging unit 10 is located upstream of the dispensing unit 26, and the dispensing unit 26 is located upstream of the spreading unit 36, in the conveying direction of the conveying unit 201. This layout enables the robot 100 to successively image plural pieces of food 16 being conveyed by the conveying unit 201, dispense a liquid onto them, and then spread the liquid on them, thereby efficiently applying the liquid to the food 16.

### [Modification 1]

In the arrangement described above, the imaging unit 10 captures an image of the container 15, so that the dispensing unit 26 and the spreading unit 36 are moved based on the position and tilt of the container 15. Alternatively, the imaging unit 10 may capture an image of the food 16, so that the dispensing unit 26 and the spreading unit 36 can be moved based on the position and tilt of the food 16.

Specifically, the imaging unit 10 captures an image of the food 16 inside the container 15 and outputs this image to the control device 40. The control device 40 then processes the image to acquire the positional information on the position and tilt of the food 16. Based on this positional information, the prescribed moving range and moving direction of the dispensing unit 26 are corrected. The dispensing unit 26 dispenses a liquid from its dispensing port while being moved according to this corrected moving range and moving direction. The liquid is hence delivered onto the food 16, forming the streak 17 of liquid.

The prescribed moving range and moving direction of the spreading unit 36 are also corrected based on the positional information on the position and tilt of the food 16. The spreading unit 36 is then moved according to the corrected moving range and moving direction. The streak 17 of the liquid is hence spread uniformly.

Since the dispensing unit 26 and the spreading unit 36 are moved based on the position and tilt of the food 16 as described above, the dispensing unit 26 and the spreading unit 36 can be moved more accurately according to the position and tilt of the food 16. The food 16 can be thus applied more uniformly to a desired area of the surface of the food 16.

The imaging unit 10 is provided on the first hand part 23 in all the embodiments described above. Alternatively, the imaging unit 10 may be provided on the second hand part 33 or somewhere else other than on the robot 100.

From the above description, it is apparent for a person skilled in the art that many improvements and other embodiments of the present disclosure are possible. Therefore, the above description should be interpreted only as illustration and is provided in order to teach a person skilled in the art the best mode for implementing the present disclosure. Details of the structures and/or functions of the present disclosure may be substantively changed without departing from the spirit of the present disclosure.

### INDUSTRIAL APPLICABILITY

The robot, the method of operating the robot, and the application system according to the present disclosure are useful in the field of industrial robots because they can readily apply the liquid to the food.

### DESCRIPTION OF REFERENCE CHARACTERS

10 Imaging Unit
15 Container
16 Food
20 First Arm
26 Dispensing Unit
30 Second Arm
36 Spreading Unit
40 Control Device
100 Robot
200 Application System
201 Conveying Unit

1. A robot configured to apply liquid to food accommodated in a container, comprising:
an imaging unit configured to image one of the container and the food;
a first arm configured to move a dispensing unit configured to dispense the liquid;
a second arm configured to move a spreading unit configured to spread the liquid dispensed on the food; and
a control device,
wherein the control device actuates the first arm to move the dispensing unit based on a position and a tilt of the one of the container and the food imaged by the imaging unit and actuates the second arm to move the spreading unit based on the position and the tilt.

2. The robot according to claim 1, wherein the first arm moves the dispensing unit in a direction in dispensing the liquid, the direction being different from a direction in which the second arm moves the spreading unit in spreading the liquid.

3. The robot according to claim 1, wherein the spreading unit has a shorter length than does the food in a direction perpendicular to the moving direction of the spreading unit in spreading the liquid.

4. The robot according to claim 1, wherein the imaging unit is provided to the first arm.

5. An application system, comprising:
the robot according to claim 1; and
a conveying unit configured to convey the container.

6. The application system according to claim 5, wherein the robot is disposed relative to the conveying unit in such a manner that:
the imaging unit is located upstream of the dispensing unit in a conveying direction of the conveying unit; and
the dispensing unit is located upstream of the spreading unit in the conveying direction.

7. A method of operating a robot including an imaging unit configured to image one of a container and food, a first arm configured to move a dispensing unit configured to dispense liquid, and a second arm configured to move a spreading unit configured to spread the liquid dispensed on the food, the method comprising:
actuating, based on a position and a tilt of the one of the container and food imaged by the imaging unit, the first arm to move the dispensing unit, and the second arm to move the spreading unit.
